(19) United States
(12) Patent Application Publication
(10) Pub. No.: US 2015/0250571 A1
(43) Pub. Date: Sep. 10, 2015

(54) Dental Device

(71) Applicant: Dan Oelgiesser, Ramat Hasharon (IL)

(72) Inventor: Dan Oelgiesser, Ramat Hasharon (IL)

(21) Appl. No.: 14/636,549

(22) Filed: Mar. 3, 2015

Related U.S. Application Data
(60) Provisional application No. 61/947,445, filed on Mar. 4, 2014.

(51) Int. Cl. A61C 17/22; A61C 17/34

(52) U.S. Cl. CPC A61C 17/228; A61C 17/349

(57) ABSTRACT

A dental arch toothbrush comprises a brush track that is configured to align to a user's dental arch, multiple brushes that are connected to the brush track and configured to engage multiple teeth of the dental arch, a series of links that connect the multiple brushes, and an actuator, attached to the series of links and configured to generate a reciprocating motion of the multiple brushes.

### CROSS-REFERENCE TO RELATED APPLICATIONS

The present application claims priority from the provisional patent application No. U.S. 61/947,445 filed by the present applicant in the U.S.A. on Mar. 4, 2014 (4 Mar. 2014).

### STATEMENT REGARDING FEDERALLY SPONSORED RESEARCH OR DEVELOPMENT

NONE

### THE NAMES OF THE PARTIES TO A JOINT RESEARCH AGREEMENT

NONE

### BACKGROUND OF THE INVENTION

1. Field of the Invention

The present invention relates to dental devices for cleaning teeth and massaging the gums, and in particular to a device for brushing teeth of a whole dental arch.

2. Description of Related Art Including Information

Tooth brushing is a necessary part of oral hygiene maintenance, aiding in the prevention of dental caries and of gingival and periodontal diseases. However, improper tooth brushing may cause traumatization of teeth and gingiva.

Dental plaque is a dense, non-calcified mass of bacterial colonies that adheres to the teeth. Plaque can be removed by mechanical methods, such as tooth brushing.

Many people have difficulty brushing their teeth properly and therefore do not remove the plaque from the tooth surfaces and the gums. The effectiveness of brushing depends on personal dexterity, form and contour of the dental arches, tooth dimensions, brush position and inclination, and the time dedicated to brushing Many people do not brush their teeth properly because of lack of knowledge, improper dexterity, lack of care, and/or insufficient brushing time.

Over the years, several full jaw toothbrushes have been disclosed. Examples of such prior art devices:
Rainer, U.S. Pat. No. 3,769,652;
Cole, U.S. Pat. No. 3,874,084;
Solow, U.S. Pat. No. 4,224,710;
Kelly, et al., U.S. Pat. No. 4,237,574;
Rabinowitz, U.S. Pat. No. 5,175,901.

These devices generally operate by manual chewing or manual manipulation of handles. A tooth brushing device disclosed in Kennedy, U.S. Pat. No. 4,011,616, includes a vibratory device at the front of the arch, which shakes bristles directed towards the teeth.

A more convenient and effective toothbrush for a full dental arch would be advantageous.

### BRIEF SUMMARY OF THE INVENTION

A dental arch toothbrush for brushing teeth of a whole dental arch is disclosed.

The dental arch toothbrush includes a brush track that is configured to match a dental arch, multiple brushes that are affixed to the brush track and configured to engage multiple teeth of the dental arch, a series of links that connect the set of brushes, and an actuator, attached to the series of links and configured to generate a linear, reciprocating motion of the multiple brushes.

According to another aspect of the present invention, various mechanical means may be used in a handle to move the brushes. For example, an electric motor may be connected to a rotating eccenter.

According to yet another aspect of the present invention, the device may be so devised as to have a comfortable angle between the brush track and the handle. In one embodiment, the axis of symmetry of the handle may be in the plane of the brush track. In another embodiment, a normal angle may be used (for example by using an eccenter). In yet another embodiment, other angle may be set for the device.

According to yet another aspect of the present invention, the brushes with their brush track may be contained in a detachable cartridge. The cartridge may include quick connect means for attaching to a handle. Preferably the handle also includes moving means such as an electric motor, and a battery.

It is to be understood that embodiments described herein comprise a combination of features and advantages intended to address various shortcomings associated with prior art devices.

The present invention should not be considered limited to the particular embodiments described hereinbelow. Various modifications, as well as numerous applications to which the present invention may be applicable, will be readily apparent to those skilled in the art to which the present invention is directed, upon review of the present disclosure, and by referring to the accompanying drawings.

### BRIEF DESCRIPTION OF THE SEVERAL VIEWS OF THE DRAWINGS

In the figures, which illustrate, by way of example, preferred embodiments of the present invention:

FIG. 1 is a schematic drawing illustrating a dental arch toothbrush;

FIG. 2 is a perspective, schematic drawing of the dental arch toothbrush, including a brush unit and handle;

FIG. 3 is a schematic drawing illustrating a cross-sectional view of the brush unit, taken in a plane between adjoining brushes;

FIG. 4 is a schematic drawing illustrating a brush track of the brush unit;

FIG. 5 is schematic drawing illustrating guide plates of the brush unit;

FIG. 6 is a schematic drawing illustrating a side view of the brush unit, with the housing removed;

FIG. 7 is a perspective, schematic drawing of the dental arch toothbrush, including a brush unit and handle for another embodiment; and

FIG. 8 is a schematic drawing illustrating guide plates of the brush unit for another embodiment.

### DETAILED DESCRIPTION OF THE INVENTION

The following detailed description is made with reference to the figures.

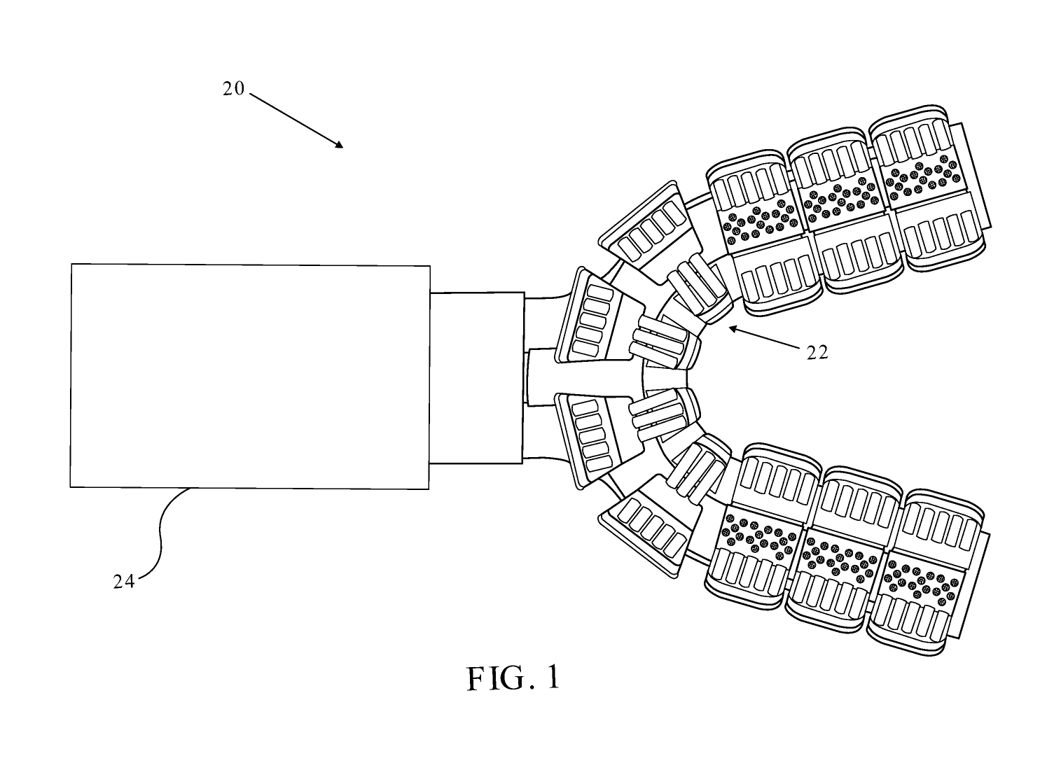

FIG. 1 is a schematic drawing of a dental arch toothbrush 20. The toothbrush includes a brush unit 22 that fits over either a superior (upper) or inferior (lower) dental arch, enabling the simultaneous brushing of all maxillary (upper) teeth, or alternatively, all mandibular (lower) teeth.

Dental arch toothbrush 20 includes a detachable handle 24. Typically, a person will employ two separate brush units, a first unit designed for the lower jaw, and a second for the upper jaw. The same handle can be employed for both units.

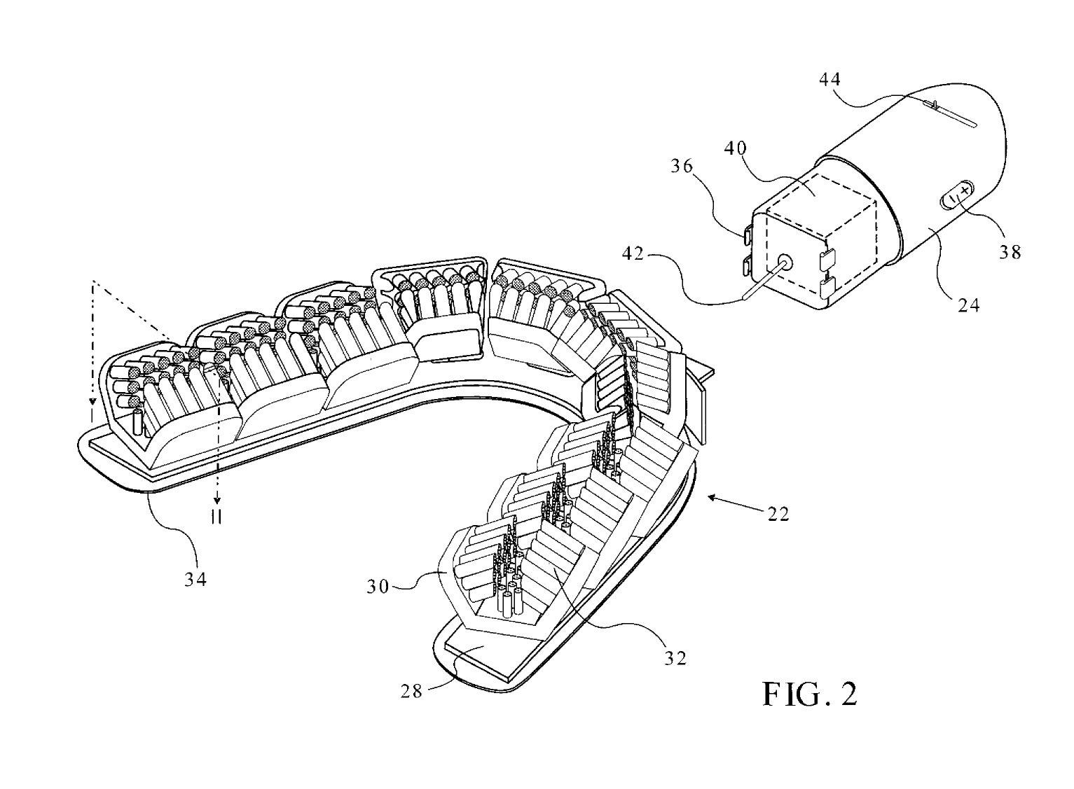

FIG. 2 is a perspective, schematic drawing of the dental arch toothbrush described above with respect to FIG. 1. Brush unit 22 includes a brush track 28, configured in an arc so as to align to the U-shape of a person's dental arch. Typically, the shape of the brush track is configured according to the particular shape of a specific user's dental arch.

Positioned on track 28 are multiple brushes 30. Each brush has an open trapezoidal shape, which opens away from the track so as to engage one or more individual teeth. Attached to the inner surfaces of each brush are multiple bristles 32.

The brush unit is mounted to a detachable, protective housing 34, which protects the underside of the brush unit.

Handle 24 is attached to the brush unit by means of a quick coupler or one or more connector pins 36. The toothbrush is operated by gripping the handle, positioning the brush unit over the dental arch, and switching on a power button 38. The brush unit is positioned such that the brushes envelope teeth of the dental arch, including molar, premolar, canine, and incisor teeth. The brushes are typically designed to reach all exposed sides of all the teeth (occlusal, lingual, and buccal), as well as the gingival margins of the gums.

Typically, brushes that will contact the posterior molar and pre-molar teeth are wider than brushes that will contact the anterior canine and incisor teeth, and include bristles to sweep the occlusal, lingual, and buccal tooth surfaces. Anterior brushes typically have only side bristles to sweep the lingual and buccal surfaces.

The power button turns on a motor 40 within the handle. Power for the motor may be provided by a rechargeable or replaceable battery inside the handle or additionally or alternatively by external power. The motor transmits mechanical power to the brush unit by means of a transmission coupler, such as motion lever 42.

Coupling of the lever to the brush unit transforms the motor motion to a linear reciprocating motion of the brushes, as described further hereinbelow. In operation, the brushes move or vibrate back-and-forth along the track in a reciprocating manner so as to sweep horizontally across the teeth, thereby cleaning the teeth and massaging and cleaning the gingival margins of the gums. The power button or a separate tempo button 44 on the handle may optionally be configured to set various patterns of speed and movement of the brushes.

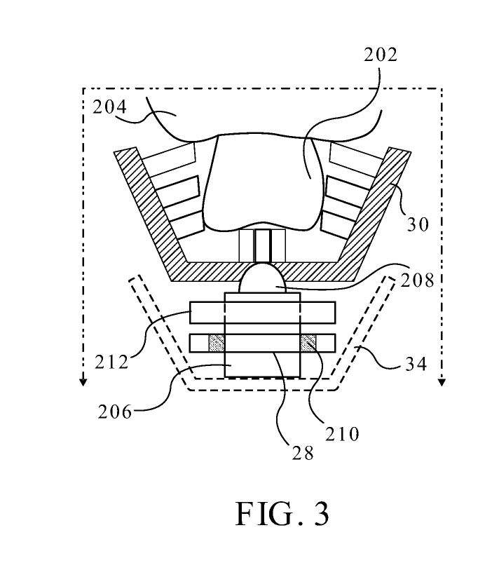

FIG. 3 is a schematic drawing illustrating a cross-sectional view of the brush unit, viewed in a plane perpendicular to the length of brush track 28, as indicated by plane I-II in FIG. 2. The brush unit is positioned to brush teeth of a dental arch, such that brush 30 is positioned so as to brush a tooth 202, as well as the gingival margins of gums 204.

Each brush of the brush unit is attached to a respective rod 206 by means of a spring attachment 208. The spring attachment may include a spring to allow partial movement of the brush, so as to maximize the surface engagement with teeth that are malocclused. The spring allows a lateral movement of the brushes (in a plane normal to the direction of movement of the brushes), so devised to allow each brush to adapt to the location of the teeth, while simultaneously preventing the brush from lagging behind in its movement.

Alternatively, the attachment may be hexagonal, or polygonal, or alternative shape to allow flexibility in the dynamic or static positioning of the brush, or a spring with a measure of sideways freedom of motion.

The rod 206 passes through a groove 210 of track 28 and through a hole in a guide plate 212. The guide plate connects two or more rods to move together. As described further herein below, the multiple rods of the brushes 30 are connected together by a series of such guide plates, such that the multiple brushes move in unison when a motive force is applied to one guide plate. The underside of the brush unit is protected by protective housing 34, as described above with respect to FIG. 2.

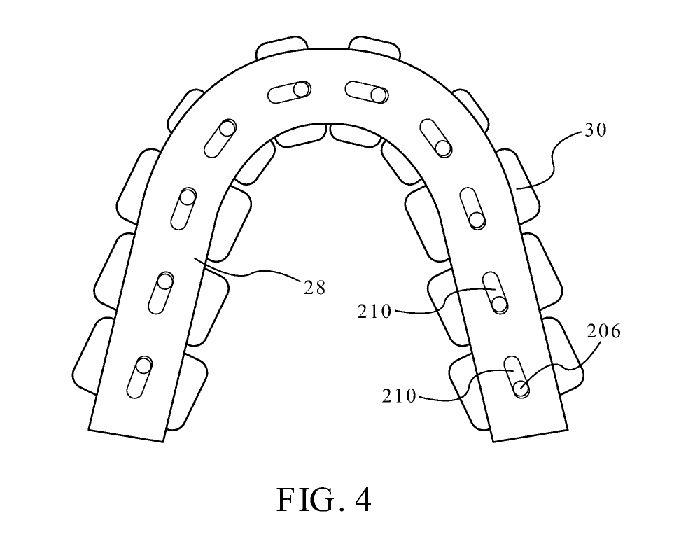

FIG. 4 is a schematic drawing illustrating a cut-away view of the underside of brush track 28, that is, the underside of the brush unit with the protective housing removed. Each brush 30 is attached to its respective rod 206, whose movement is guided by one or more grooves 210 in the brush track. Grooves may be several millimeters in length, permitting movement of the brushes when a reciprocating force is applied to one or more of the plates. Grooves are positioned along a center line of the track, the length of each groove being parallel to the edges of the track.

The positions and lengths of the grooves may be customized for a particular user.

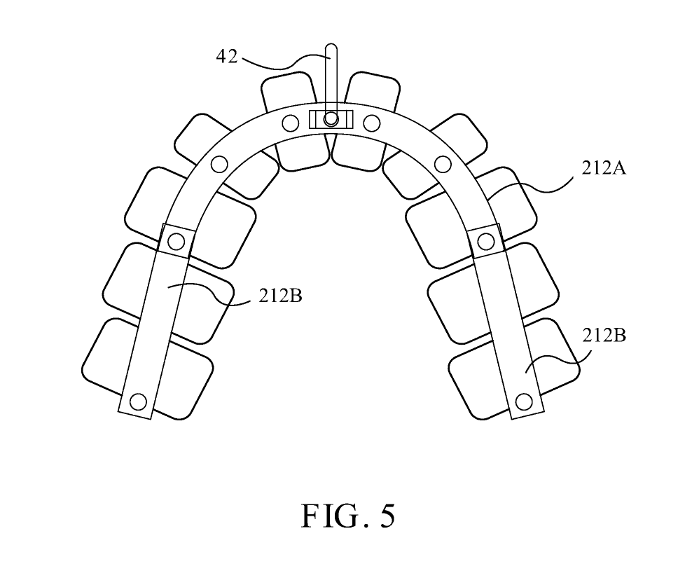

FIG. 5 is schematic drawing illustrating a cut-away view of the underside of the brush unit, with both the protective housing and the brush track removed from the view, such that the guide plates are in view. As described above with respect to FIG. 3, each rod 206 passes through one or two guide plates. In one embodiment, the brush unit includes three guide plates that are positioned under the brush track, these being an anterior guide plate 212A, and left and right posterior guide plates 212B. A single rod passing through two plates serves as a hinge, permitting the angle between the adjoining plates to change as the plates move back and forth along the track. In alternative embodiments, more guide plates may be included in the series of guide plates that stretch the length of the brush track.

Lever 42 described with respect to FIG. 2 is coupled to the forward edge of the anterior guide plate.

In an alternative embodiment, the guide plates may be positioned between the protective housing and the brush track. In further embodiments, the motive force may be transferred from the handle to the brush unit by other mechanical means known in the art, such as a pinion coupled to rack gear on the anterior guide plate, or by eccenter means as shown below.

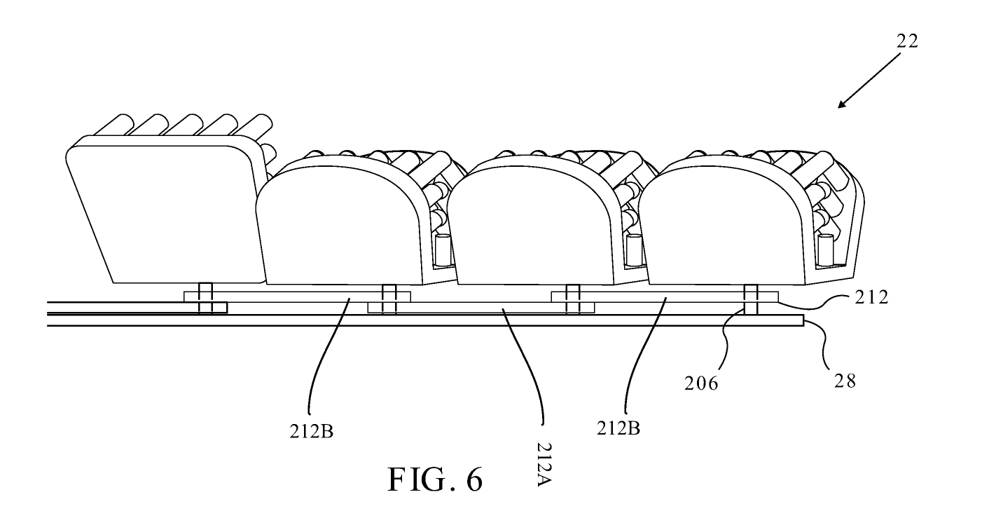

FIG. 6 is a schematic drawing illustrating a side view of the brush unit, with the housing removed so that brush track 28 is visible, as well as rods 206 and guide plates 212. Each rod passes through one or two guide plates, such that all guide plates are linked in a series.

The housing, brush track, and brushes may be custom produced for a user or selected for the user from among a range of standard sized elements. The dental arch toothbrush may be provided as a kit that includes upper and lower brush units, as well as the detachable handle.

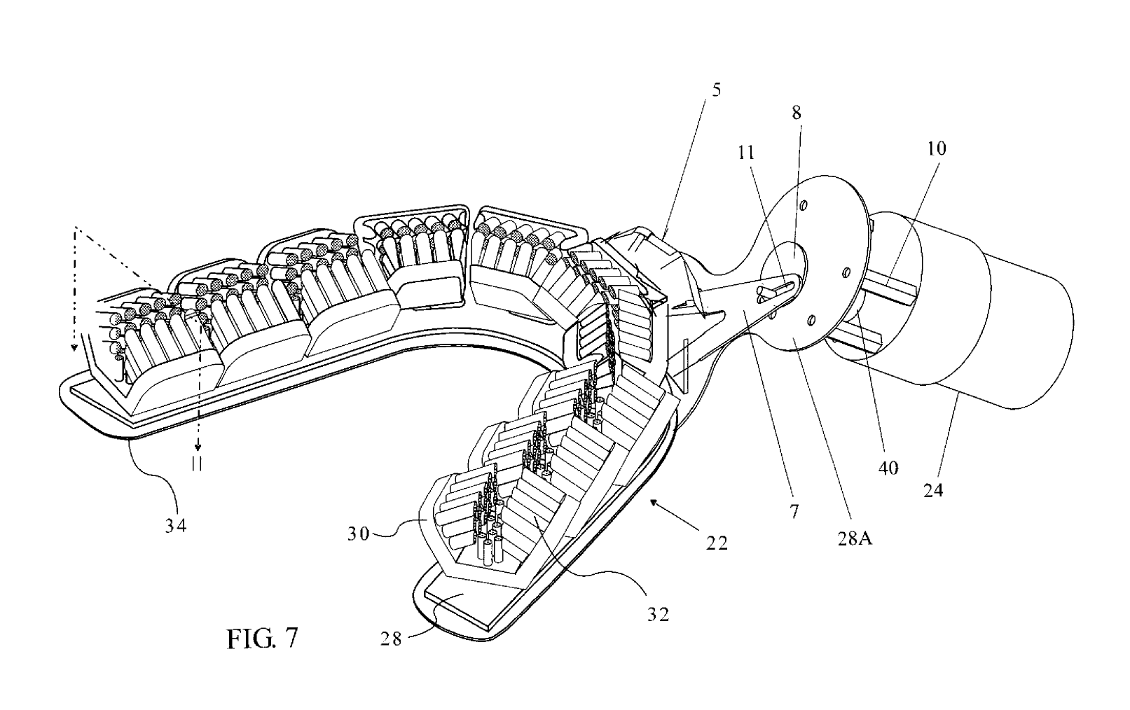

FIG. 7 is a perspective, schematic drawing of the dental arch toothbrush, including a brush unit 22 and a handle 24 for another embodiment.

In this embodiment, the handle 24 is mounted at an angle with the plane of the brush unit 22. The angle may be 90 arc degrees, or a slant angle as may be comfortable to the user.

In the embodiment as illustrated, the brush unit 22 is used to brush the superior (upper) dental arch, enabling the simultaneous brushing of all the maxillary (upper) teeth.

The brush unit 22 is detachably connected to the handle 24 using snap-on means as known in the art, which enable easy connection or separation of the units 24 and 22.

Similarly, a second brush unit (not shown) belonging to that person, but adapted to the shape of the inferior (lower) dental arch, may be connected to the handle 24, enabling the simultaneous brushing of all the mandibular (lower) teeth.

In the embodiment as shown, an electric motor 40 in the handle 24 rotates eccenter means 8. The brushes are moved using eccenter means 8 in the handle 24. The eccenter 8 with its pin rotates and engages a slot 11 in the motion coupling means 7. The motion coupling means 7 is an extension of the anterior guide plate 212A.

Thus, rotation of the motor in the handle 24 causes a linear, back and forth movement of the brushes 30 along their track 28 in the brush unit 22. The brush track extension 28A is not moving, rather it is part of the track 28 and provides a support for the moving brushes. The structure may also include standoff means 10, or quick connect means.

In other aspects, this embodiment is somewhat similar to that in FIG. 2.

In a preferred embodiment of the present invention, the brush unit 22 with the brush track 28 may be contained in a detachable cartridge. The cartridge may include quick connect means for attaching to the handle 24.

Preferably the handle 24 also includes moving means (such as an electric motor) and a battery.

The quick connect means include attaching means for the fixed part with the track 28, and attaching means for the moving part (the brushes).

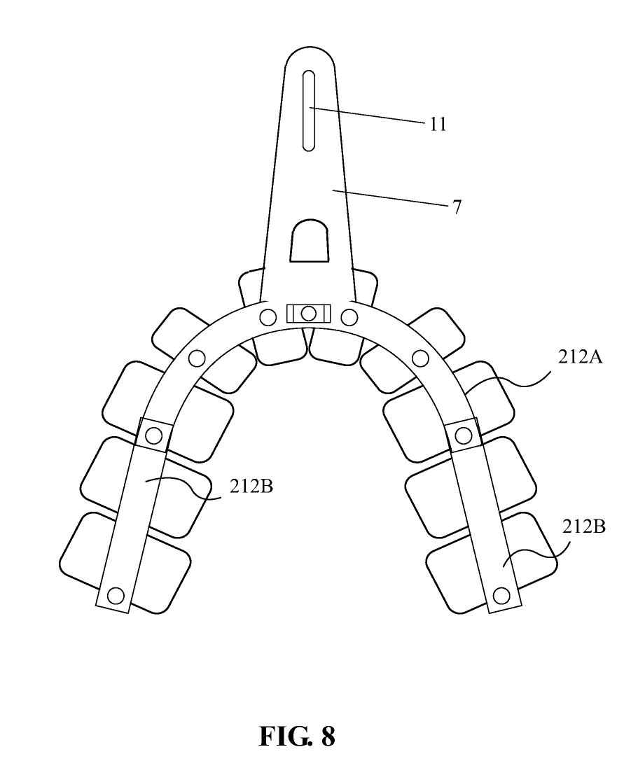

FIG. 8 is schematic drawing illustrating a cut-away view of the underside of the brush unit, with both the protective housing and the brush track removed from the view. In this embodiment, the brush unit includes three guide plates that are positioned under the brush track, these being an anterior guide plate 212A, and left and right posterior guide plates 212B. In the embodiment as shown, the brushes are moved using the motion coupling means 7 which are connected to the eccenter means 8 in the handle 24 (see FIG. 7).

The motion coupling means 7 is an extension of the anterior guide plate 212A.

In other aspects, this embodiment is somewhat similar to that in FIG. 5.

It is to be understood that preferred embodiments have been described to illustrate the technology disclosed, not to limit its scope. Those of ordinary skill in the art will recognize a variety of equivalent variations.

I claim as follows:

1. A dental arch toothbrush, comprising:
a brush track configured to align to a dental arch;
multiple brushes coupled to the brush track and configured to engage multiple teeth of the dental arch;
a series of links connecting the set of brushes; and
an actuator, coupled to one or more of the links and configured to generated a reciprocating motion that moves the brushes.

2. The dental arch toothbrush of claim 1, further including a handle, configured to generate a mechanical force and to couple the force to the actuator.

3. The dental arch toothbrush of claim 2, wherein the handle is configured to permit adjustment of the mechanical force so as provide multiple patterns of the reciprocating motion of the multiple brushes.

4. The dental arch toothbrush of claim 1, wherein the brushes are affixed to the brush track by means of rods, wherein the series of links connect the multiple brushes by connecting the rods.

5. The dental arch toothbrush of claim 4, wherein the brushes are affixed to the rods by means of hex ball attachments.

6. The dental arch toothbrush of claim 1, wherein the series of links comprise plates.

7. The dental arch toothbrush of claim 1, wherein the brush track is customized for an individual user's dental arch.

8. The dental arch toothbrush of claim 1, wherein the brush track includes grooves, and wherein the reciprocating motion of the multiple brushes is constrained by the grooves.

9. The dental arch toothbrush of claim 1, wherein the actuator comprises an electric motor and eccenter means rotated by the motor, and wherein the coupling between the actuator and the links comprises motion coupling means connected to one of the links.
